(19) United States
(12) Patent Application Publication
(10) Pub. No.: US 2006/0136268 A1
(43) Pub. Date: Jun. 22, 2006

(54) System and method for maintaining the association of healthcare orders in a healthcare plan in a computerized pharmacy application

(75) Inventors: Michael A. Ash, Parkville, MO (US); John Q. DeVerter, Liberty, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC.

(21) Appl. No.: 11/022,540

(22) Filed: Dec. 22, 2004

(51) Int. Cl. G06F 19/00; G06Q 40/00

(52) U.S. Cl. 705/3; 705/4

(57) ABSTRACT

A system and method for maintaining association of healthcare medication orders in a healthcare plan in a computerized environment are provided. A first and second medication order are received for a healthcare plan for a patient. The first and second medication orders for the healthcare plan for the patient are associated with one another and the association of the first and second medication orders is maintained when the first and second order are transferred to a pharmacy application to be filled.

### CROSS-REFERENCE TO RELATED APPLICATIONS

This application is related by subject matter to the inventions disclosed in the commonly assigned application U.S. application No. (not yet assigned) (Attorney Docket Number CRNI.117207), entitled “System and Method for Associating Healthcare orders in a Healthcare Plan in a Computerized Environment”, and U.S. application No. (not yet assigned) (Attorney Docket Number CRNI. 118115), entitled “System and Method for Maintaining the Association of Healthcare Orders from Healthcare Plan in a Computerized Medical Administration Record” which were filed on even date herewith.

### STATEMENT REGARDING FEDERALLY SPONSORED RESEARCH OR DEVELOPMENT

Not applicable.

### TECHNICAL FIELD

The present invention relates generally to the field of computer software. More particularly, the invention relates to a system and method for associating healthcare orders in a healthcare plan in a computerized environment.

### BACKGROUND OF THE INVENTION

Healthcare orders are requests placed by healthcare providers for procedures, medications, laboratory tests, evaluations, treatments, and nursing tasks to be done for a patient. In a non-electronic healthcare order system, orders from different categories in one healthcare plan, such as medication, labs, diagnostic tests, clinical outcomes, orders based on a scheduled appointment and nursing orders, are documented on a single piece of paper. A healthcare plan comprises multiple orders for treatment for a particular problem or ailment. For example, a cancer healthcare plan may comprise multiple medication orders and laboratory testing orders. Once these orders are reviewed by a healthcare provider, the necessary orders for different categories are sent to the correct location to be completed or filled. For example, if one order includes a medication, a medication paper order is sent to the pharmacy to be filled. If one of the orders in the healthcare plan is for a laboratory test, a paper laboratory requisition form is sent to the laboratory. In the paper healthcare ordering system, it is always possible to go back to the original paper order set containing all of the orders for the healthcare plan. An example of a healthcare plan or procedure would be chemotherapy protocol that includes multiple orders for medications, laboratory tests, and diagnostic tests.

In an electronic healthcare order environment, if a set of orders is placed for a healthcare plan, once the orders have been reviewed they are dispersed to the appropriate location, such as the pharmacy or laboratory application. However, once these orders have been dispersed to the appropriate application to be completed or filled, there is no way to look at the orders for the healthcare plan to see what other orders were part of the plan. Furthermore, unlike the paper environment, there is no paper to revert back to that contains all of the orders for the particular plan ordered for the patient.

Thus, it would be beneficial to have a system and method in an electronic healthcare ordering system that allows orders to be associated and kept together after they are distributed to the proper application to be filled. This way the orders stay together through a continuum so that a clinician can see why a particular medication in a healthcare plan was ordered based on a combination of the other orders in the same healthcare plan.

### SUMMARY

In one embodiment of the present invention, a method for maintaining association of healthcare medication orders in a healthcare plan in a computerized environment is provided. A first and second medication order are received for a healthcare plan for a patient. The first and second medication orders for the healthcare plan for the patient are associated with one another and the association of the first and second medication orders is maintained when the first and second order are transferred to a pharmacy application to be completed.

In another embodiment, a system for maintaining association of healthcare medication orders in a healthcare plan in a computerized environment is provided. The system comprises a receiving component for receiving a first and second medication order for a healthcare plan for a patient and an associating component for associating the first and second medication orders for the healthcare plan for the patient. The system further comprises a maintaining component for maintaining the association of the first and second order when the first and second order are transferred a pharmacy application to be filled.

In yet another embodiment, a system for maintaining association of healthcare medication orders in a healthcare plan in a computerized environment is provided. The system comprises means for receiving a first and second medication order for a healthcare plan for a patient and means for associating the first and second medication orders for the healthcare plan for the patient. The system further comprises means for maintaining the association of the first and second medication orders when the first order and second order are transferred to a pharmacy application to be filled.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a diagram of an electronic healthcare ordering system to be used in accordance with an embodiment of the present invention;

FIG. 3 is an exemplary table of data to be used in accordance with an embodiment of the present invention;

FIG. 4 is a flow diagram of a method for transmitting healthcare orders to the proper application to be filled and maintaining the association of the orders;

FIG. 5 is a flow diagram of a method for associating changes or comments to a healthcare order in accordance with an embodiment of the present invention;

FIG. 6 is a flow diagram of a method for identifying healthcare orders according to a particular healthcare plan in accordance with an embodiment of the present invention;

FIG. 7 is a screen of problems exhibited by a patient in accordance with an embodiment of the present invention;

FIG. 8 is a screen of possible healthcare plans for a particular problem for the patient and associated orders for that plan in accordance with an embodiment of the present invention;

FIG. 9 is a screen showing the pharmacy application and orders for a patient that have been associated in accordance with an embodiment of the present invention;

FIG. 10 is a screen of a pharmacy application with a link to historical information for the order;

FIG. 11 is a screen showing the documentation of changes to a healthcare order in accordance with an embodiment of the present invention;

FIG. 12 is a screen showing a medication administration record for a patient in accordance with an embodiment of the present invention;

FIG. 13 is a screen showing orders for a particular healthcare plan in a medication administration record in accordance with an embodiment of the present invention;

FIG. 14 is screen showing the healthcare plan that an order belongs to in accordance with an embodiment of the present invention;

FIG. 15 is a historical screen showing changes made to an order in a healthcare plan in accordance with an embodiment of the present invention; and

FIG. 16 is a screen of a medication administration record for a patient showing the change in start date and time for medications to be administered.

### DETAILED DESCRIPTION OF THE INVENTION

The present invention provides a system and method for associating healthcare orders for a healthcare plan in a computerized environment. The present invention further provides a method for maintaining the association of the orders in a healthcare plan when the orders are transferred to an application to be filled or completed.

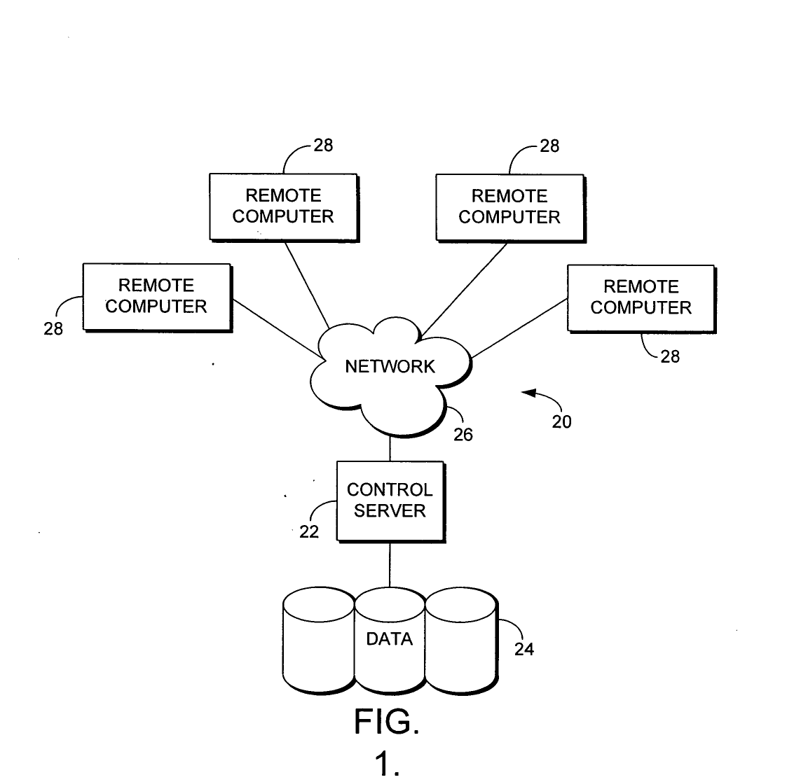

With reference to FIG. 1, an exemplary medical information system for implementing the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home healthcare environment. Clinicians include, but are not limited to, the treating physician, specialists such as surgeons, radiologists and cardiologists, emergency medical technicians, physician's assistants, nurse practitioners, nurses, nurse's aides, pharmacists, dieticians, microbiologists, laboratory experts, genetic counselors, researchers, veterinarians, students, and the like. The remote computers may also be physically located in non-traditional medical care environments so that the entire healthcare community is capable of integration on the network. Remote computers 28 may be a personal computer, server, router, a network PC, a peer device, other common network node healthcare device or the like, and may include some or all of the elements described above relative to server 22. The devices can be personal digital assistants, or other like devices. Computer network 26 may be a local area network (LAN) and/or a wide area network (WAN), but may also include other networks including Internet networks via wired or wireless capability. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. By way of example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Commands and information may also be sent directly from a remote healthcare device to the server 22. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

Although the method and system are described as being implemented in a WINDOWS operating system, operating in conjunction with an Internet-based system, one skilled in the art would recognize that the method and system can be implemented in any system supporting the receipt and processing of healthcare orders. As contemplated by the language above, the method and system of the present invention may also be implemented on a stand-alone desktop, personal computer, or any other computing device used in a medical environment or any of a number of other locations.

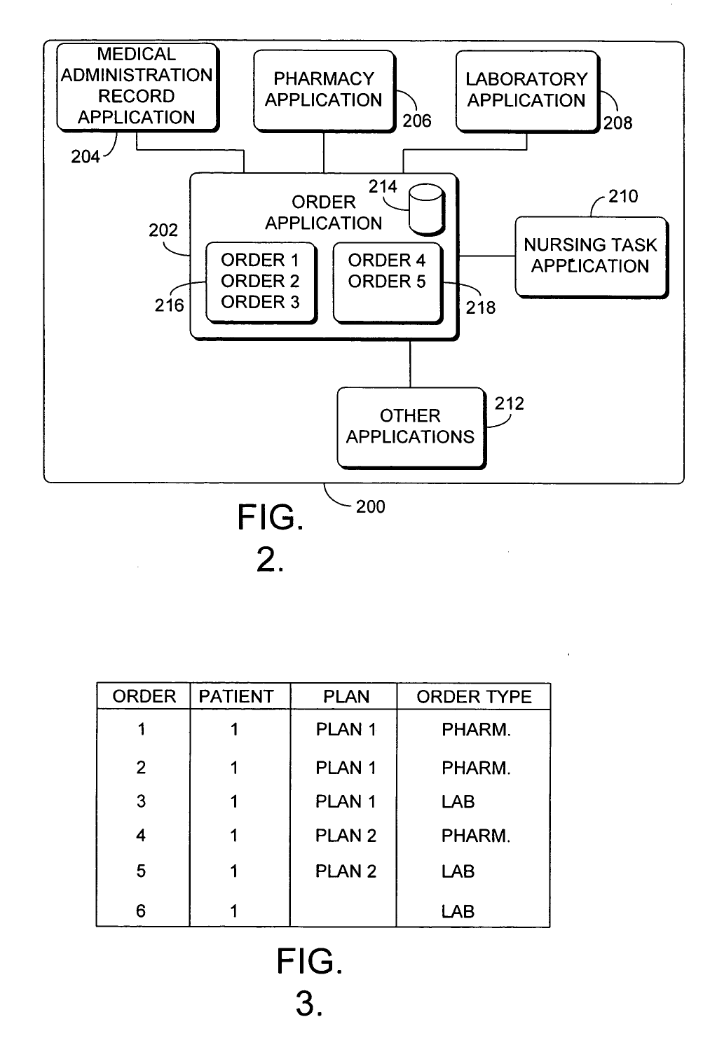

FIG. 2 illustrates an exemplary healthcare ordering system 200 including an order application 202, medication administration record application 204, a pharmacy application 206, a laboratory application 208, a nursing task application 210, and other applications 212. An exemplary order application is the POWERPLANS solution offered by Cerner Corporation at 2800 Rockcreek Parkway, North Kansas City, Mo.

The order application includes a storage device 214 which may be any type of storage device including a table or database. A healthcare provider places orders to be performed for the patient in the order application 202. These orders are requests for medical treatment, medications, laboratory tests, diagnostics, and other needed procedures to treat a patient. The orders may also be requests for appointments, resources and other scheduled tasks.

In FIG. 2, two healthcare plans, 216 and 218 have been ordered for a patient. The healthcare plan 216 comprises three orders for the patient, order 1, order 2, and order 3. Healthcare plan 218 comprises two orders, order 4 and order 5. The order application 202 maintains association of these orders in a healthcare plan by storing the association in storage device 214. Storage device 214 may be a table, a database, or any other storage device for storing the association of orders for healthcare plan. For example, the order application maintains the association of order 1, order 2, and order 3 in the healthcare plan 216 even after they have been distributed to their respective applications to be filled. This information can be stored in storage device 214.

The medication administration record application 204 is a display of medications to be administered to a patient at the point of administration, such as the patient's bedside. A pharmacy application 206 includes medications that have been ordered for a patient but have not yet been filled by the pharmacy and delivered to the patient. The laboratory application 208 includes laboratory testing that needs to be done for the patient on a patient sample and the ability to document the results of the laboratory test results. The nursing task application 210 creates tasks to be completed by nurses when an order is placed for nursing care. For example, a nursing task may include taking a patient's blood pressure, vital signs, bathing the patient, and measuring and weighing the patient. Other applications 212 may include radiology applications, pathology applications, and scheduling applications.

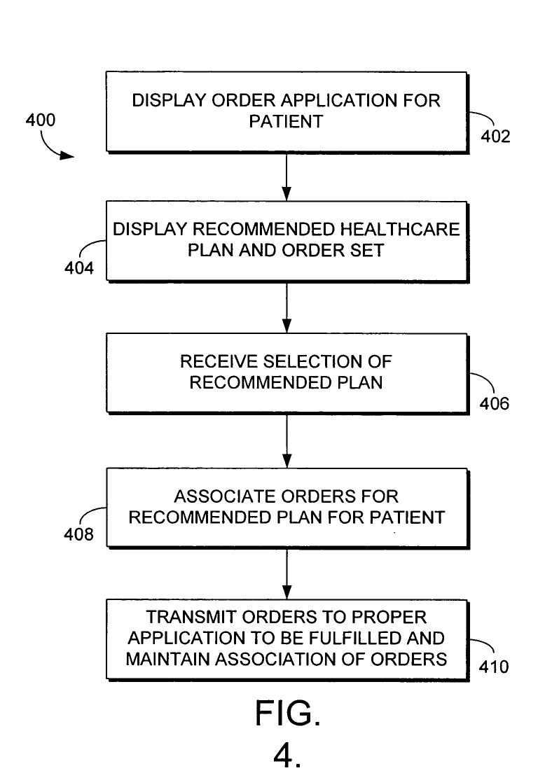

With reference to FIG. 3, a table storing information regarding healthcare plans and associated orders for a patient is shown. As can be seen in FIG. 3, healthcare plan 1 contains three orders, orders 1, 2 and 3 for patient 1. The orders comprise two pharmacy orders and one laboratory testing order. A second plan has been ordered for the patient 1. It is identified as plan 2 and comprises two orders, orders 4 and 5. One order is for a pharmacy need and one for laboratory testing. The orders within each plan are associated and the association is stored in storage device 214 of FIG. 2 for future use. For example, the association of orders 1, 2, and 3 for plan 1 is stored and the association of orders 4 and 5 for plan 2 is stored.

Once healthcare orders have been reviewed, they are sent to the appropriate application to be filled or otherwise completed. For example, medication orders 1 and 2 for plan 1 are sent to the pharmacy application 206 to be filled and delivered to the patient. Laboratory order 3 of plan 1 is sent to the laboratory application 208 to be completed. However, after the orders are dispersed, the association of orders to a plan is maintained.

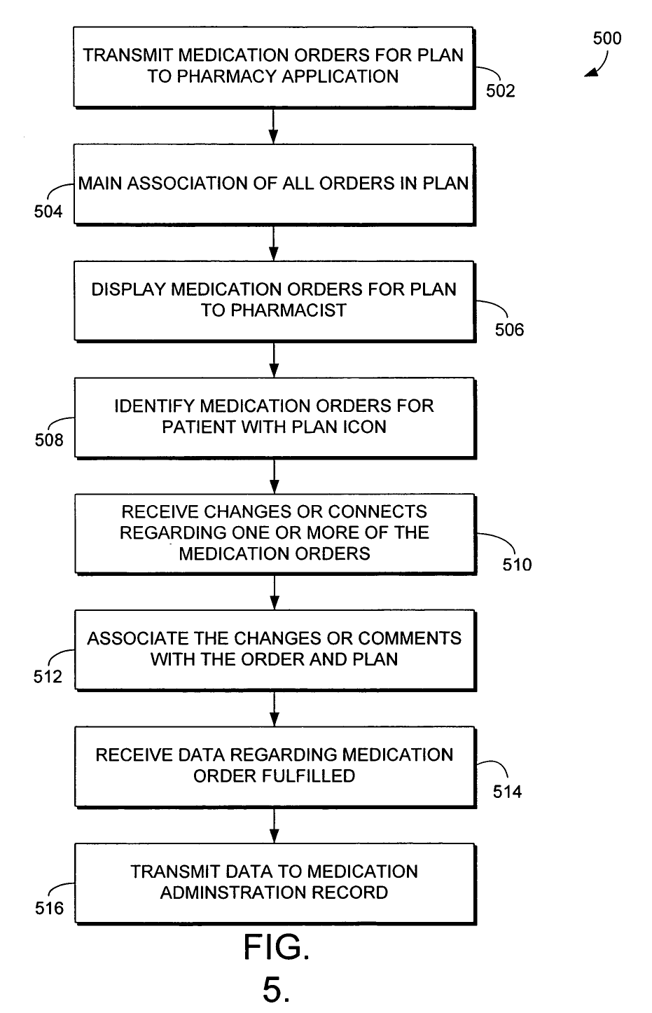

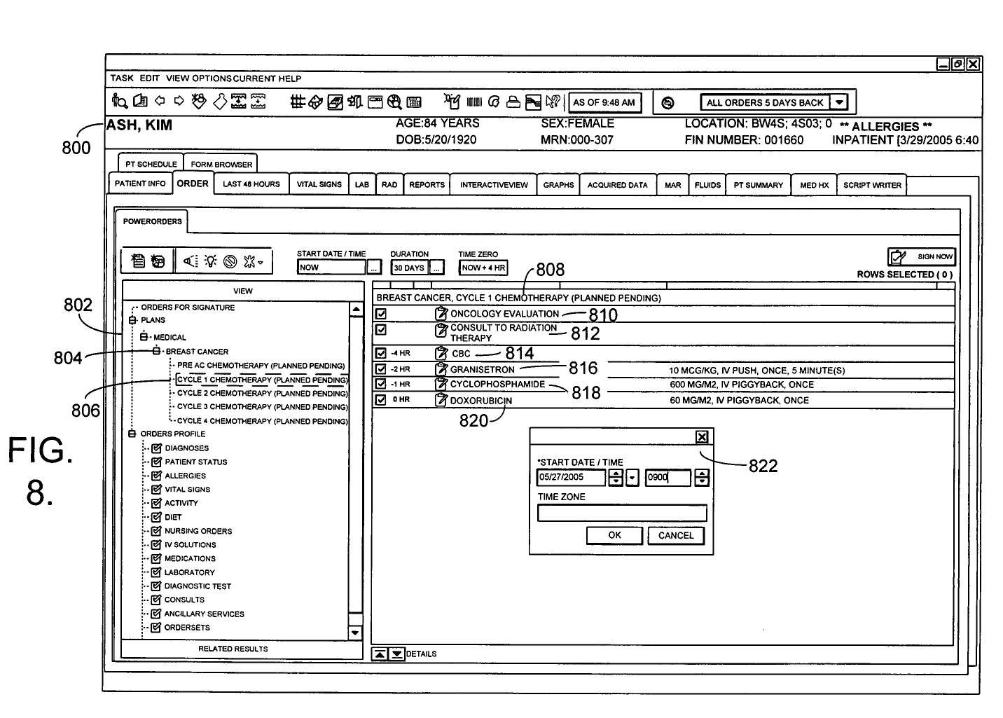

With reference to FIG. 4, a flow diagram of a method 400 for transmitting orders in a healthcare plan to a proper application to be filled and maintaining the association of those orders. At block 402, the order application for a patient is displayed. An exemplary order application for a patient is shown in FIG. 7. The order application displayed may include problems or issues for which the patient needs to be treated. For example, the patient may have been diagnosed with cancer. At block 404 of FIG. 4, the recommended plans for treating the problem or ailment of the patient are displayed. The recommended healthcare plan for the problem diagnosed to the patient includes the orders that must be filled or otherwise completed for the recommended plan. For example, if the patient has breast cancer, a recommended healthcare plan for treating breast cancer is displayed and the orders to be filled for that recommended healthcare plan for treating cancer are also displayed. An exemplary healthcare plan for treating breast cancer orders to be filled may include medications, anti-emetics, chemotherapy fluids, laboratory tests, procedures, and radiology consults.

At block 406, the selection of the recommended healthcare plan to be followed is received. The selection is made by a healthcare provider based on the problem or ailment of the patient. In an alternative embodiment, the healthcare provider selects individual orders to create an individualized healthcare plan for the problem or ailment of the patient. In this instance, each order would be selected individually and added to a plan rather than selecting a recommended plan. At block 408, the orders for the plan selected are associated, and that association is stored. For example, multiple orders may make up the recommended healthcare plan such as multiple medication orders, laboratory orders, consults, nursing tasks, and other procedures. These are all identified to be part of a healthcare plan for treating a problem or ailment of a patient and identification or association of orders in the healthcare plan is stored so that it may be accessed in the future.

At block 410, the orders of the healthcare plan are transmitted to the proper application to be filled, all the while maintaining the association of the orders. For example, if the healthcare plan is made up of two medication orders and one laboratory order, the two medication orders are sent to the pharmacy application to be filled and the laboratory order is sent to the laboratory testing application to be completed. However, the association of the orders in the healthcare plan is maintained in storage device 214 of FIG. 2 for reference.

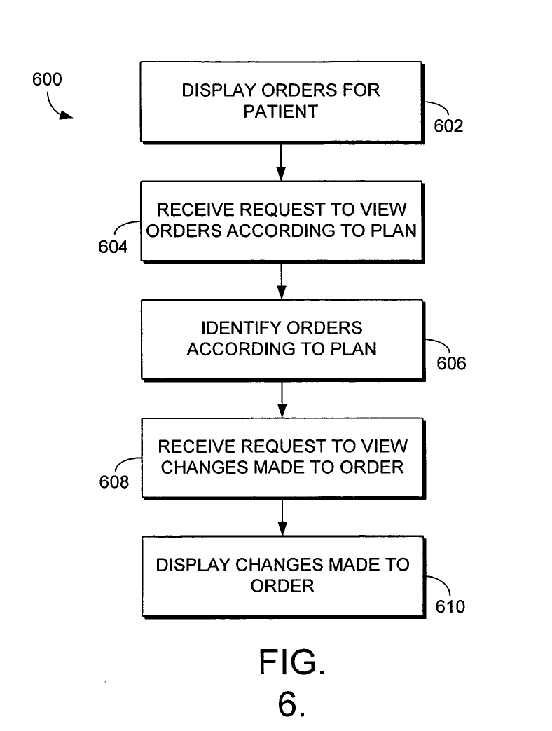

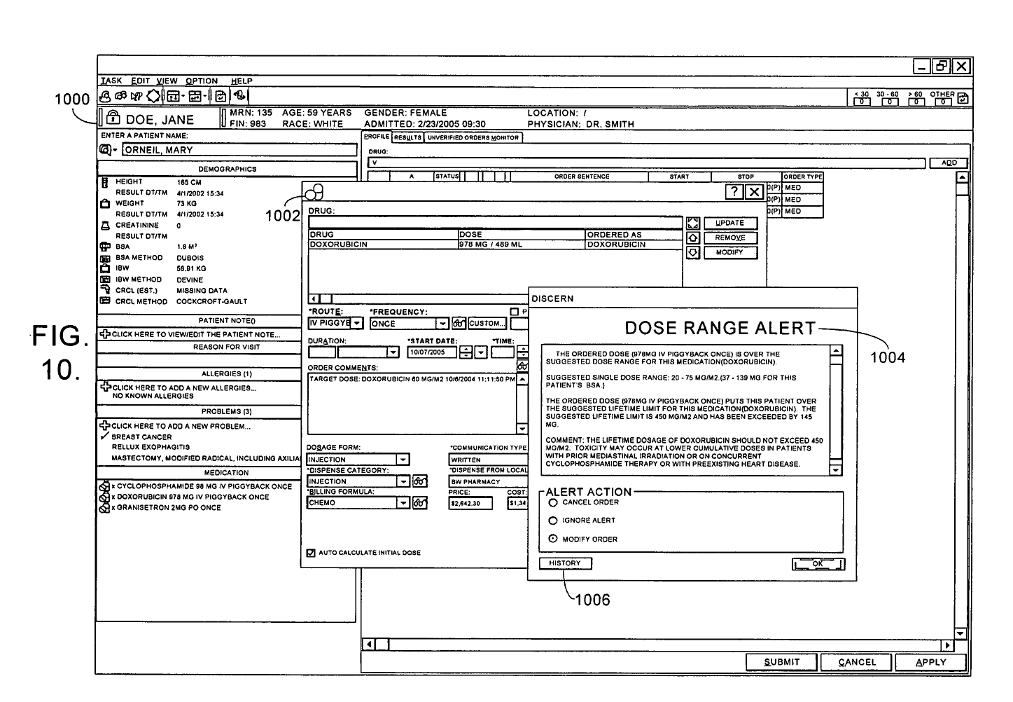

With reference to FIG. 5, a method 500 for associating changes or comments with an order that is part of healthcare plan is shown. At block 502, the medication orders that are part of a healthcare plan are transmitted to the pharmacy application. At block 504, the association of all the orders in this particular healthcare plan are maintained. For example, this association is maintained in storage device 214 of FIG. 2. At block 506 of FIG. 5, the medication orders for the healthcare plan to be filled are displayed to a pharmacist. An exemplary display of medication orders to be filled in a pharmacy application is shown in FIG. 9. Referring again to FIG. 5, the medication orders for the patient are identified at block 508. The medication orders for a particular plan for a patient may be identified by listing them separately, or by an identifier such as an icon. For example, in FIG. 9, medication orders 904, 906, and 908 for a chemotherapy healthcare plan for fictitious patient, Kim Ash, are identified by the same icon.

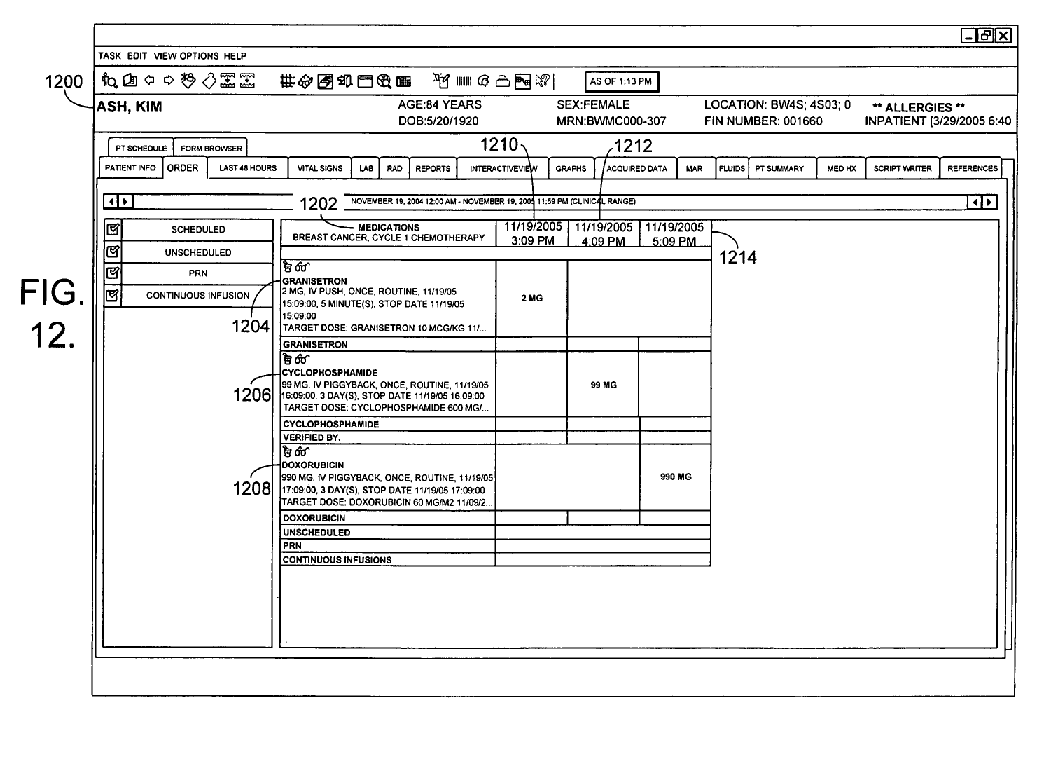

Referring again to FIG. 5, at block 510, changes or comments regarding one or more of the medication orders in a healthcare plan are received. The changes may be made to the medication dose, form, frequency, or route of administration. The comments include an explanation describing the reasoning for making a change (or leaving the order unchanged) and whether the prescribing physician was consulted. Exemplary changes or comments made to a medication order are shown in FIG. 11.

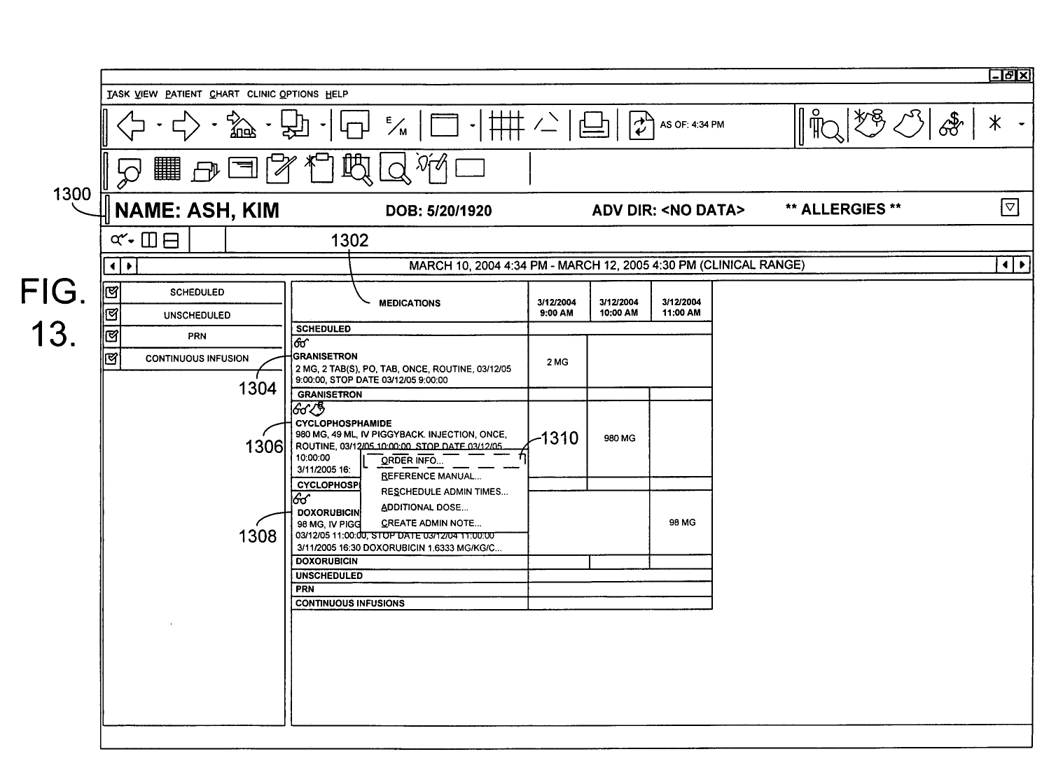

Referring again to FIG. 5, at block 512, the comments or changes made by the pharmacist to the medication order are associated with the order and plan. For example, these changes are stored for the order in storage device 214 of FIG. 2. Referring again to FIG. 5, at block 514, data is received indicating that the medication order has been filled by the pharmacy and is ready to be administered to the patient. At block 516, this data is transmitted to the medication administration record application for the patient to be used at the administration site of the medication. An exemplary medication administration record is shown in FIG. 12.

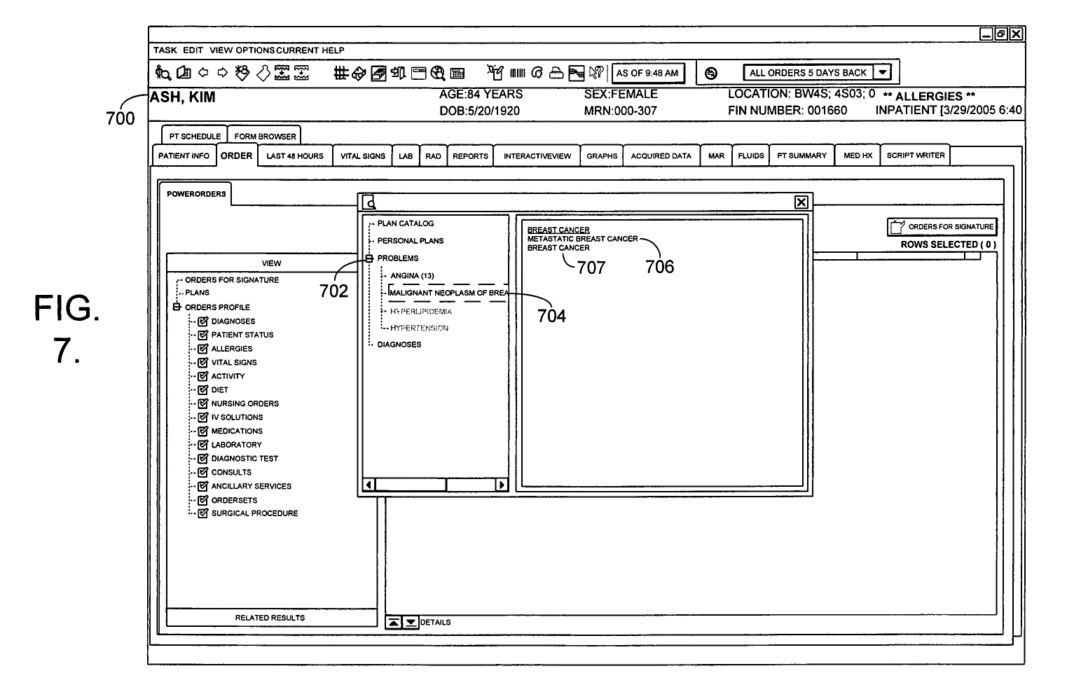

Referring next to FIG. 6, a method 600 for displaying changes to a medication order is shown. At block 602, orders for a patient are displayed. At block 604, a request to view orders according to the healthcare plan is received. At block 606, the orders are identified according to plan. For example, in the medication administration records shown in FIG. 12, only orders relating to the breast cancer chemotherapy plan for the patient are shown in the medication administration record by filtering orders so that only orders for a particular plan are displayed. These orders may also be identified using an indication or icon identifying a particular plan. Any variety of identifiers or icons may be used to identify orders according to a healthcare plan.

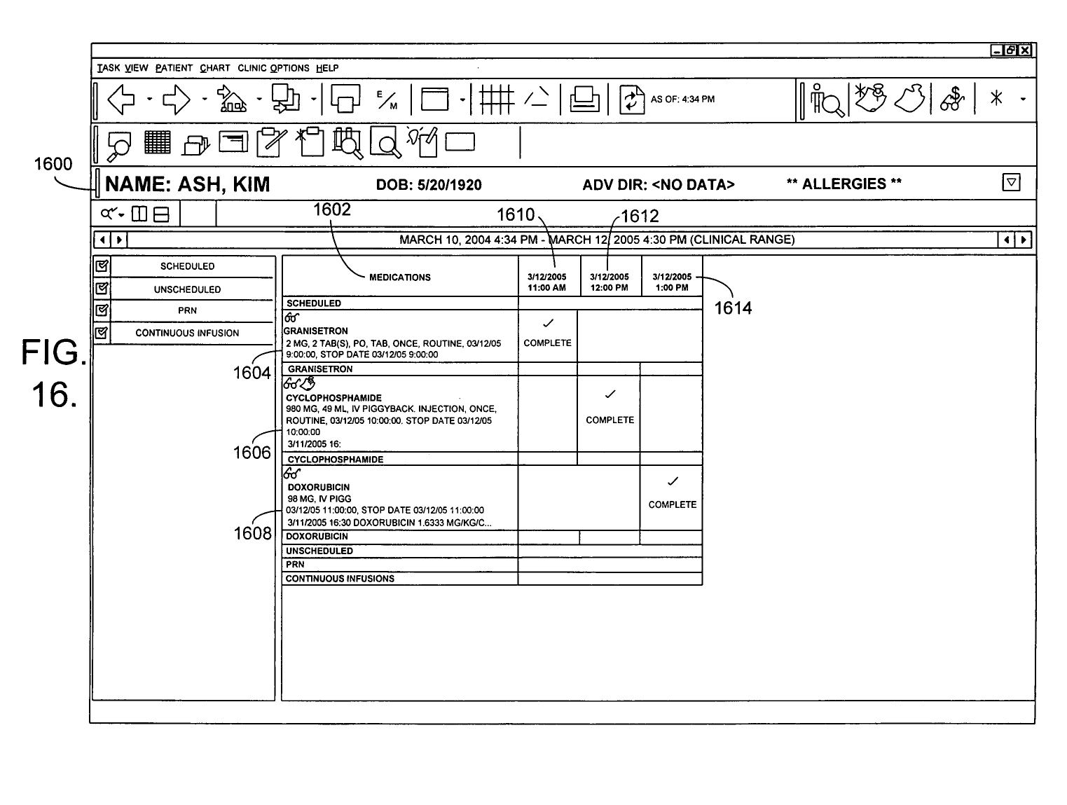

At block 608, the systems receives a request to view changes made to a medication order. This request may come from a nurse or other healthcare provider before administering medication to a patient to determine why the medication prescribed is different from what is normally administered to the patient or why changes have been made to the medication order. This saves time as it prevents the nurse from calling the pharmacy and the doctor to determine if the amount prescribed to be administered to the patient in the medication administration record is correct. At block 610, a database containing the changes made to the order is accessed and the changes made to the order are displayed. For example, in FIG. 15, the changes and any comments that were made to the medication order are shown.

With reference to FIG. 7, a screen 700 showing problems or ailments 702 for fictitious patient, Kim Ash, are shown. The problems that the patient is suffering from include malignant neoplasm of the breast 704 and angina. This information can be obtained from a storage device such as the patient's electronic medical record. In this example, the plans that address the malignant neoplasm of the breast 704 are breast cancer plan 707 and metastatic breast cancer plan 706.

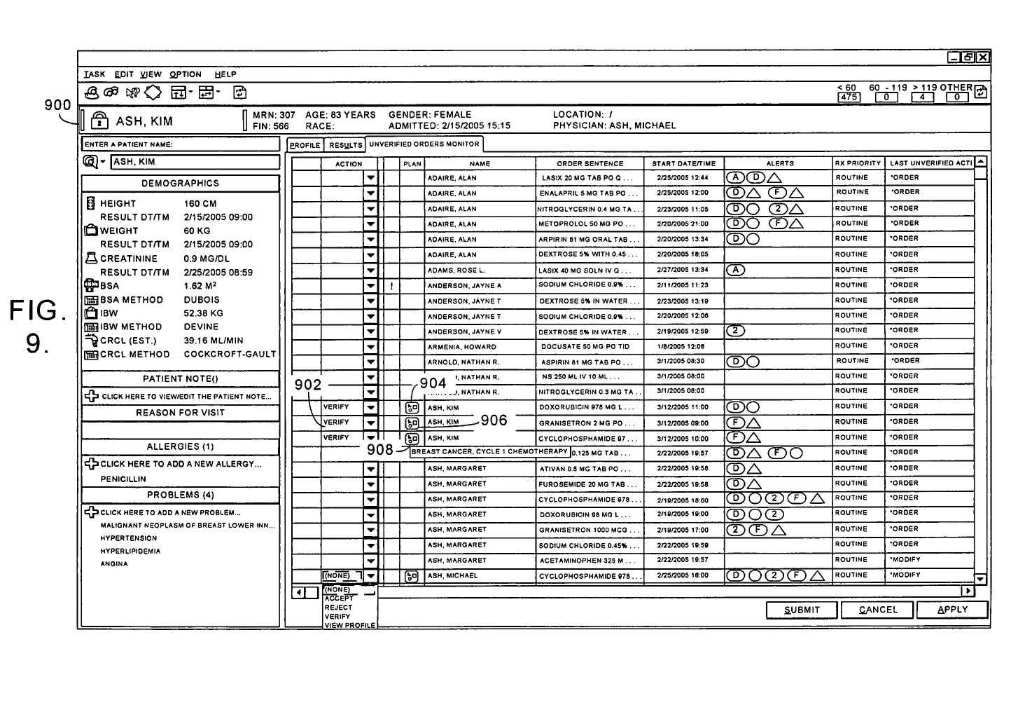

With reference to FIG. 8, a screen showing the five phases or sections of the plan breast cancer 804 and orders that make up a particular phase or section of the plan 808 are shown. For example, for fictitious patient, Kim Ash, the five phases of the breast cancer plan are displayed in the left hand column. These phases include Pre AC Chemotherapy, Cycle 1 Chemotherapy, Cycle 2 Chemotherapy, Cycle 3 Chemotherapy and Cycle 4 Chemotherapy. Cycle 1 chemotherapy 806 is selected by a healthcare provider and the predefined orders 810 through 820 for Cycle 7 Chemotherapy are displayed.

As can be seen for the breast cancer Cycle 1 chemotherapy healthcare plan phase 808, the orders included in the Cycle 1 chemotherapy phase are: an oncology evaluation 810, a consult to radiation therapy 812, a CBC 814, granisetron 816, cyclophosphamide 818, and doxorubicin 820. The start time and date of the first medication can be entered into a field 822. The orders are sequenced as a group, and the time and sequence can be changed as a group or discontinued as a group. Once these orders are reviewed and released to be filled, each of the individual orders are sent to the proper application to be filled or completed. For example, the orders for granisetron 816, cyclophosphamide 818, and doxorubicin 820 are sent to a pharmacy application to be filled by a pharmacy while the complete blood count (CBC) order 814 is sent to a laboratory application to be completed. However, the association is maintained in a database so that it may be reviewed later.

With reference to FIG. 9, the medication orders for doxorubicin, cyclophosphamide and granisetron have been released to the pharmacy application and displayed in pharmacy application display 900. The pharmacy application display shows all orders for medications that need to be filled for patients. The patients are listed alphabetically in the display. As can be seen in the pharmacy application display 900, the three medication orders 902 for the breast cancer phase 1 plan of fictitious patient, Kim Ash, are identified by the same icon 904, 906, and 908. This way the pharmacist is able to easily determine the medication orders for Cycle 1 chemotherapy plan for fictitious patient, Kim Ash. A pharmacist can use the identification of orders in a plan to make clinical decisions for plan orders as a group rather than individually.

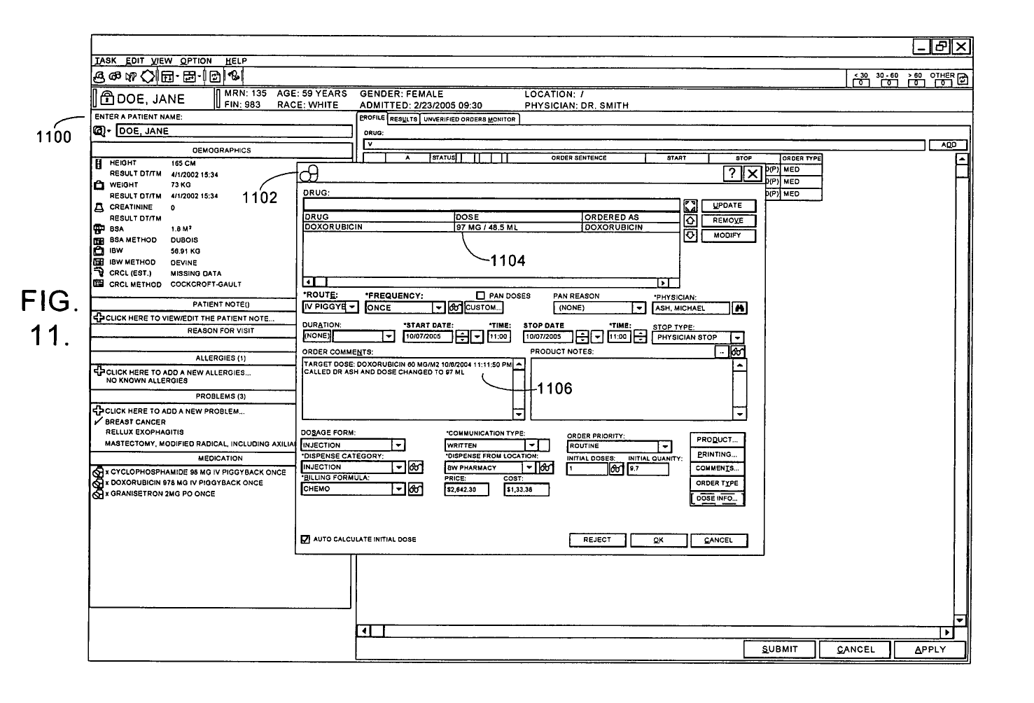

With reference to FIG. 10, when the pharmacist is verifying the medication order 1000 to be administered to a patient, if the dose range is out of normal range, a dose range alert 1004 will be displayed. For example, the dosage prescribed doxorubicin 1002 for fictitious patient, Jane Doe, puts the patient over the suggested lifetime limit for doxorubicin. A variety of logic may be used to determine if the dose is out of range. From the dose range alert, the pharmacist can view the history 1006 of the order, in order to determine if the medication order is actually correct in light of other orders in the plan. For example, the doxorubicin medication order for a different dosage amount may be based on laboratory tests in the same plan that will be performed for the patient or other medications in the same plan to be administered to the patient.

With reference to FIG. 11, if the pharmacist determines that the medication ordered for the patient is incorrect, based on additional information and/or conversations with the patient's physician, the pharmacist can enter these changes and modify the dosage amount 1104. The pharmacist enters comments 1106 to communicate the change to others who will view this medication order and want to know why it was changed. For example, in FIG. 11, the pharmacist has changed the dosage amount of doxorubicin from 978 mg/489 ml to 97 mg/48.5 ml in field 1104. The pharmacist has also entered comments in field 1106 indicating the physician had been consulted and dosage amount changed.

With reference to FIG. 12, a medication administration record 1200 is shown. The medication administration record includes all medications 1202 for the breast cancer Cycle 1 chemotherapy healthcare plan to be administered to the patient. The medical administration record application is viewed by the nurse or healthcare provider at the patient's bedside to determine what medications are to be administered to the patient and when. The medications 1202 for the breast cancer Cycle 1 chemotherapy are granisetron 1204, cyclophosphamide 1206 and doxorubicin 1208. These medications are to be administered at different times 1210, 1212 and 1214, respectively.

The medical administration record may be filtered to display only medications for a certain healthcare plan. For example, in FIG. 12, only medications for the breast cancer Cycle 1 plan ordered for fictitious patient, Kim Ash, are shown. Alternatively, all medication orders for a patient may be listed in the medication administration record application with identifiers or icons identifying medication orders by healthcare plan. For example, medication orders from a first healthcare plan are identified by an icon while medication orders from a second healthcare plan are identified by a different icon.

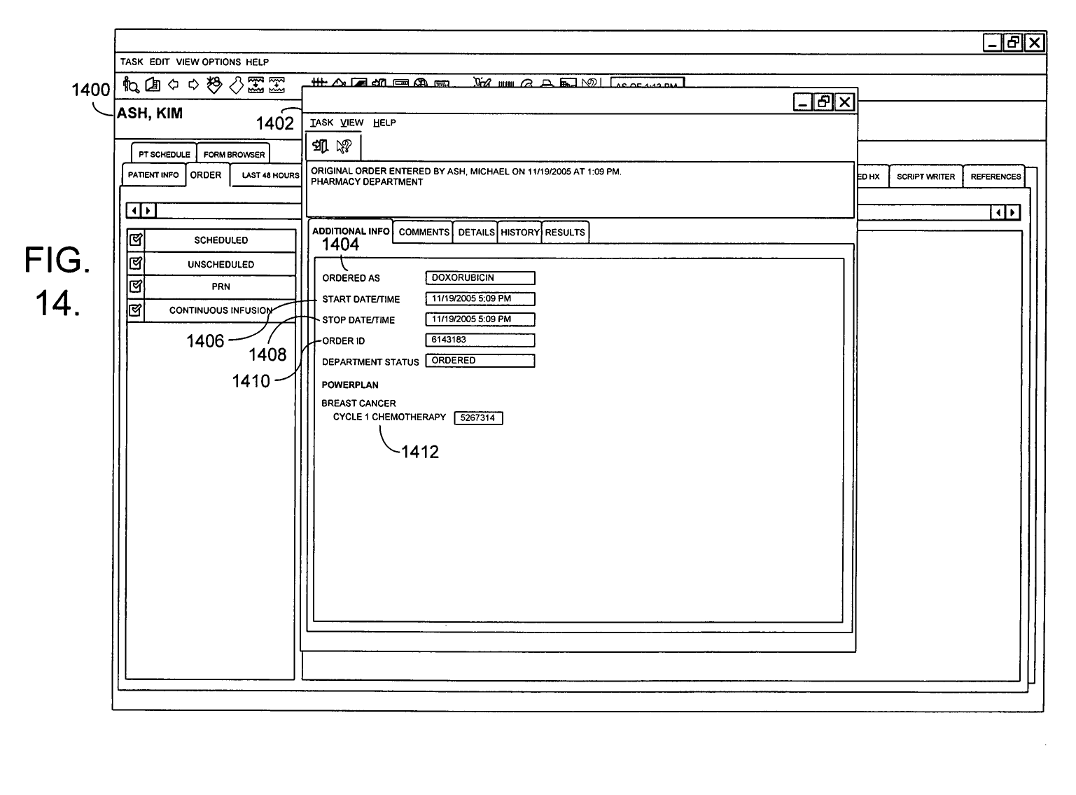

With reference to FIG. 13, from the electronic medication administration record 1300, a nurse or healthcare provider can view data related to a medication order. In FIG. 13, medications 1302 to be administered to fictitious patient, Kim Ash, include granisetron 1304, cyclophosphamide 1306, and doxorubicin 1308. By highlighting a medication order, the nurse or healthcare provider can link to additional data 1310 for the medication order.

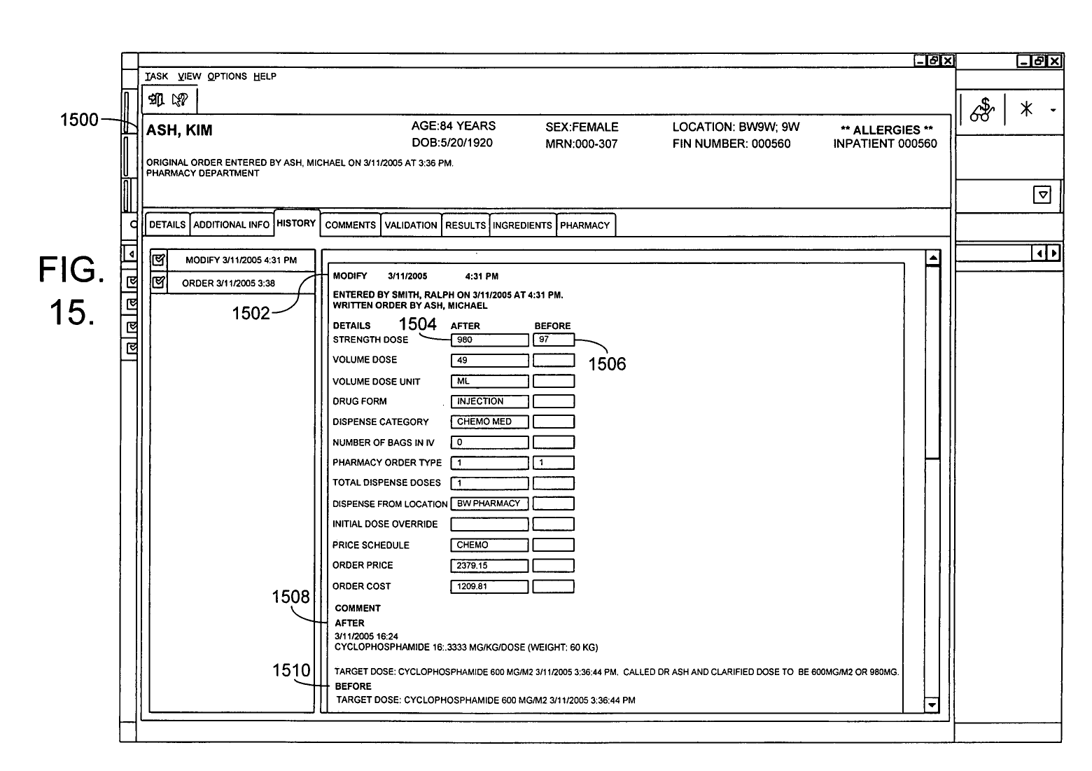

For example, if doxorubicin 1310 is selected from FIG. 13, the additional information regarding the doxorubicin can be viewed in FIG. 14. With reference to FIG. 14, additional information regarding the medication order 1402 is shown. The additional information includes the ordered medication 1404, the start date and time 1406, the stop date and time 1408, the order identification number 1410, and the healthcare plan that the order belongs to 1412. From this view, it can be seen that the order for doxorubicin for fictitious patient Kim Ash belongs to breast cancer Cycle 1 chemotherapy plan 1412 with a reference number of 5267314.

With reference to FIG. 15, a nurse or other healthcare provider can easily refer to a history of any changes made to a medication order. For example, in this screen 1500 for fictitious patient, Kim Ash, it can be seen that the medication order for cyclophosphamide 1502 was modified on Mar. 11, 2004 at 4:31 p.m. The strength dose 1506 before the modification was 97, and the strength dose 1504 of the medication after the modification was 980. The comments 1508 and 1510 made regarding the change include that the doctor was called to clarify the dosage range as the target dose was incorrect before.

With reference to FIG. 16, the medication administration record for the medications in the Cycle 1 chemotherapy plan are shown. In this screen 1600 for fictitious patient, Kim Ash, the medications 1602 include granisetron 1604, cyclophosphamide 1606, and doxorubicin 1608. The entire time sequence for the Cycle 1 chemotherapy plan is changed by changing the start date and time of one of the related orders to the plan. For example, in this screen the first medication to be administered, granisetron 1604, was changed from being administered at 9:00 a.m. on Mar. 12, 2005 as shown in FIG. 13 to being administered at 11:00 a.m. on Mar. 12, 2005 in FIG. 16. Because one of the medication orders' administration times has changed and the other medication orders 1606 and 1608 are linked to the medication order 1604, the administration time for medication orders 1606 and 1608 is also forwarded two hours.

The present invention has been described in relation to particular embodiments, which are intended in all respects to be illustrative rather than restrictive. Alternative embodiments will become apparent to those skilled in the art but do not depart from its scope. For example, in additional to the dose range alert described herein, a number of other decision support processes may be incorporated in embodiments of the invention. Many alternative embodiments exist, but are not included because of the nature of the invention. A skilled programmer may develop alternative means for implementing the aforementioned improvements without departing from the scope of the present invention.

It will be understood that certain features and subcombinations of utility may be employed without reference to features and subcombinations, and are contemplated within the scope of the claims. Not all blocks in the various figures need to be carried out in the specific order described.

The invention claimed is:

1. A method for maintaining association of medication healthcare orders in a healthcare plan in a computerized environment, the method comprising:
receiving a first and second medication order for a healthcare plan for a patient;
associating the first and second medication orders for the healthcare plan for the patient with one another; and
maintaining the association of the first and second medication orders, when the first and second medication orders are transferred to a pharmacy application to be completed.

2. The method of claim 1, further comprising:
receiving a third medication order for the healthcare plan for the patient.

3. The method of claim 2, further comprising:
associating the first, second and third medication orders for the healthcare plan.

4. The method of claim 3, further comprising:
maintaining the association of the first, second and third medications orders when the orders are transferred to the pharmacy application.

5. The method of claim 1, further comprising:
receiving changes to one or both of the first and second medication orders.

6. The method of claim 5, wherein the changes are to one of the dose of medication, frequency of administration of medication and route of administration of medication.

7. The method of claim 6, further comprising:
receiving comments regarding the changes made the medication order.

8. The method of claim 7, further comprising:
associating the comments and changes with the medication order and healthcare plan.

9. The method of claim 8, wherein the changes and comments made to the medication order may be viewed from a medication administration record application.

10. The method of claim 1, wherein the pharmacy application includes one or more prescriptions for medications for one or more patients to be filled by a pharmacy.

11. The method of claim 1, further comprising:
identifying the first and second medication orders as part of the healthcare plan in the pharmacy application.

12. The method of claim 11, wherein the first and second medication orders are identified as part of the healthcare plan in the pharmacy application by the same identifier or icon.

13. A computer readable medium comprising the method of claim 1.

14. A computer program comprising the method of claim 1.

15. A system for maintaining association of medication healthcare orders in a healthcare plan in a computerized environment, the system comprising:
a receiving component for receiving a first and second medication order for a healthcare plan for a patient;
an associating component for associating the first and second medication orders for the healthcare plan for the patient with one another; and
a maintaining component for maintaining the association of the first and second medication orders, when the first and second medication orders are transferred to a pharmacy application to be completed.

16. The system of claim 15, wherein the receiving component receives a third medication order for the healthcare plan for the patient.

17. The system of claim 16, wherein the associating component associates the first, second and third medication orders for the healthcare plan.

18. The system of claim 17, wherein the maintaining component maintains the association of the first, second and third medications orders when the orders are transferred to the pharmacy application.

19. The system of claim 15, further comprising:
a second receiving component for receiving changes to one or both of the first and second medication orders.

20. The system of claim 19, wherein the changes are to one of the dose of medication, frequency of administration of medication and route of administration of medication.

21. The system of claim 20, wherein the second receiving component receives comments regarding the changes made the medication order.

22. The system of claim 21, further comprising:
a second associating component for associating the comments and changes with the medication order and healthcare plan.

23. The system of claim 22, wherein the changes and comments made to the medication order may be viewed from a medication administration record application.

24. The system of claim 14, wherein the pharmacy application includes one or more prescriptions for medications for one or more patients to be filled by a pharmacy.

25. The system of claim 14, further comprising:
an identifying component for identifying the first and second medication orders as part of the healthcare plan in the pharmacy application.

26. The system of claim 25, wherein the first and second medication orders are identified as part of the healthcare plan in the pharmacy application by the same identifier or icon.

27. A system for maintaining association of medication healthcare orders in a healthcare plan in a computerized environment, the system comprising:
means for receiving a first and second medication order for a healthcare plan for a patient;
means for associating the first and second medication orders for the healthcare plan for the patient with one another; and
means for maintaining the association of the first and second medication orders, when the first and second medication orders are transferred to a pharmacy application to be completed.

28. The system of claim 27, further comprising:
means for receiving changes to one or both of the first and second medication orders.

29. The system of claim 28, wherein the changes are to one of the dose of medication, frequency of administration of medication and route of administration of medication.

30. The system of claim 29, further comprising:
means for receiving comments regarding the changes made the medication order.

31. The system of claim 30, further comprising:
means for associating the comments and changes with the medication order and healthcare plan.

32. The system of claim 31, wherein the changes and comments made to the medication order may be viewed from a medication administration record application.

33. The system of claim 27, further comprising:
means for identifying the first and second medication orders as part of the healthcare plan in the pharmacy application.
